(19) United States
(12) Patent Application Publication
(10) Pub. No.: US 2010/0165635 A1
(43) Pub. Date: Jul. 1, 2010

(54) LED UNIT

(75) Inventors: Chin-Chung Chen, Tu-Cheng (TW); Hai-Wei Zhang, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: Fu Zhun Precision Industry (Shen Zhen) Co., Ltd., Shenzhen City (CN); Foxconn Technology Co., Ltd., Tu-Cheng (TW)

(21) Appl. No.: 12/345,521

(22) Filed: Dec. 29, 2008

(51) Int. Cl. F21V 7/00; F21V 99/00

(52) U.S. Cl. 362/307; 362/311.1

(57) ABSTRACT

An LED unit includes a reflector, an LED mounted in the reflector, and a lens detachably mounted within the reflector and covering the LED. The reflector includes a bottom plate in which the LED is received, an annular sidewall and a tapered sidewall interconnecting the annular sidewall and the bottom plate. The lens includes a disk and dome protruding upwardly from the disk. The reflector forms a pair of buckles at two opposite sides thereof to abut against the disk, thereby fixing the lens therein. A bottom face of the disk confronting the LED and a top face of the dome remote from the LED are all aspheric surfaces.

### BACKGROUND OF THE INVENTION

1. Field of the Invention

The present invention relates to an light emitting diode (LED) unit and, more particularly, to an LED unit comprising a lens having two aspheric surfaces producing a relatively narrow beam with large intensity.

2. Description of Related Art

LEDs have been available since the early 1960's. LED use has increased in a variety of applications, such as in residential, traffic, commercial, and industrial settings, because of the high light-emitting efficiency of LEDs. Atypical LED includes an LED die emitting light and a transparent encapsulant enveloping the LED die. The encapsulant protects the LED die from contamination and damage, and acts as a lens. However, due to a size limitation of the encapsulant, the light cannot be sufficiently converged and would diverge after passing through the encapsulant. The divergent light results in an insufficient brightness of the LED. Therefore, light-adjusting devices, such as a catadioptric light distribution system, are desired for further collimation of the light from the LED.

A typical catadioptric light distribution system includes a reflector mounted below and surrounding the LED, and a convex lens mounted above the LED. The reflector reflects the light radiated toward the lens from a perimeter of the encapsulant. The lens culminates the light emitted from the LED and reflected by the reflector into a single beam. Using the catadioptric light distribution system, most of the light emitted from the LED can be converged, and the brightness of the LED increased.

However, since the lens of the catadioptric light distribution system is often spherical shaped, the lens cannot effectively culminate the light into a narrow beam. The light incident near a circumferential edge of the lens, after passing through the spherical surface of the lens, would still be deflected divergently, resulting in a scattered light beam. The scattered light beam presents a dramatic light wane along a direction away from the lens, which is unsuitable for long-distance illumination.

What is needed, therefore, is an LED unit which can overcome the above-mentioned disadvantages.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled view of a catadioptric light distribution system of an embodiment of an LED unit.

FIG. 2 is an exploded view of FIG. 1.

FIG. 3 is similar to FIG. 2, but viewed from another aspect.

FIG. 4 is a cross-sectional view of FIG. 1, with an LED of the LED unit placed within the catadioptric light distribution system.

FIG. 5 is a side view of FIG. 1.

### DETAILED DESCRIPTION OF THE EMBODIMENTS

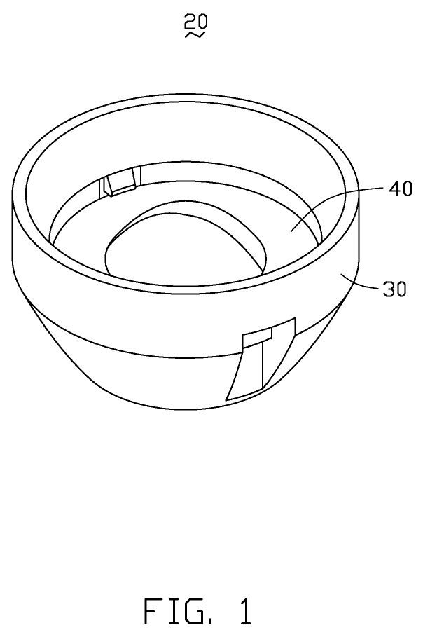

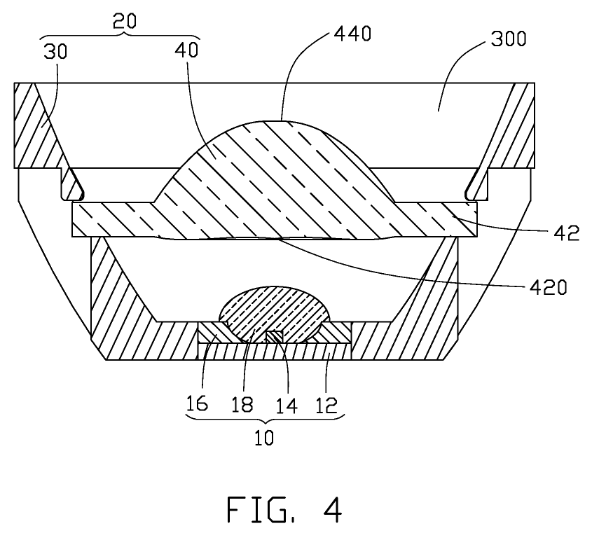

Referring to FIGS. 1 and 4, an embodiment of an LED unit includes an LED 10 (see FIG. 4) and a catadioptric light distribution system 20 receiving the LED 10. The LED 10 may be any variety of LEDs or light emitting devices, however, a light emitting device with a great heat dissipation capability is preferred. In the illustrated embodiment, the LED 10 includes a base 12, an LED die 14 fixed on the base 12, a substrate 16 fixed on the base 12 and surrounding the LED die 14, and a dome-shaped encapsulant 18 on the substrate 16 and encapsulating the LED die 14. The base 12 absorbs heat from the LED die 14 and disperses the heat to an ambient atmosphere, as well as conducting electricity into the LED die 14 from power supplying elements (not shown). The substrate 16 may be bowl-shaped to reflect and converge light emitted from sides of the LED die 14 towards a top of the encapsulant 18 In one embodiment, the encapsulant 18 has a semispherical surface at an outmost side thereof. The encapsulant 18 functions as a primary lens to guide the light emitted from the LED die 14 and reflected by the substrate 16 into a conical light pattern.

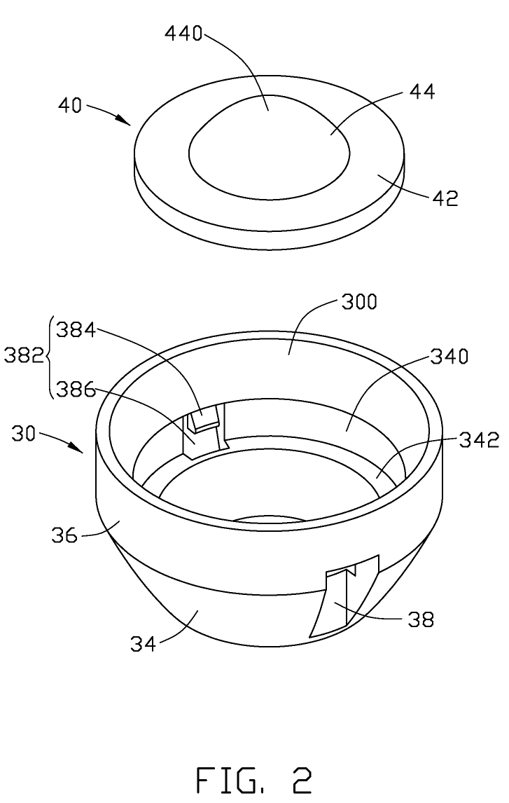

Also shown in FIG. 2, the catadioptric light distribution system 20 comprises a reflector 30 containing the LED 10 and a lens 40 detachably mounted within the reflector 30 at a distance spaced from the LED 10. Both of the reflector 30 and the lens 40 may be made from a transparent material, such as epoxy resin, silicon, and so on. It is noted that optical axes of the encapsulant 18, the reflector 30, and the lens 40 are collinear, so that the light emitted from the LED die 14 can be accurately collimated. To effectively collect the light striking an inner circumference of the reflector 30 from the LED 10, the inner perimeter of the reflector 30 may have a parabolic surface, so that the striking light may be reflected into a parallel light pattern. In other embodiments, the inner perimeter of the reflector 30 may have other shaped surfaces, such as a spherical surface, an elliptical surface, and a flat surface, as long as the same functionalities thereof are provided. In addition, to reflect as much light as possible, the inner perimeter of the reflector 30 may be coated with a reflective layer (not labeled). A material of the reflective layer would be reflective such as gold, copper, and ceramic.

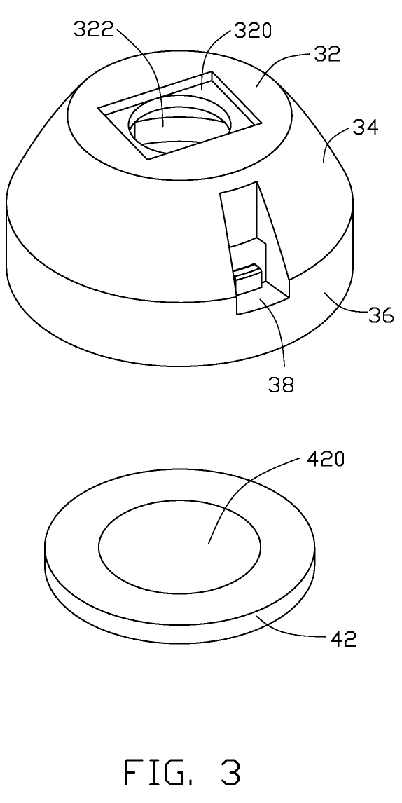

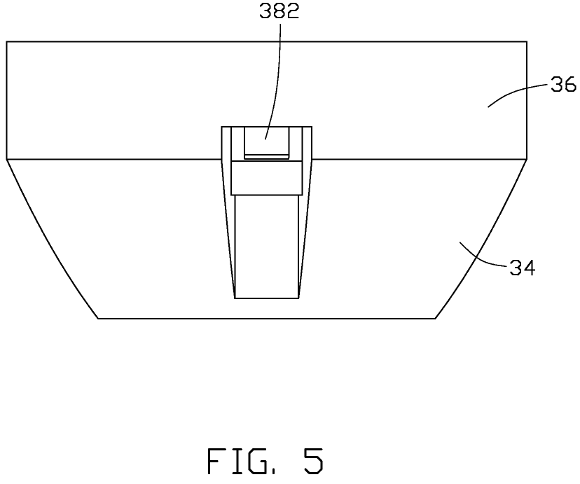

Also referring to FIGS. 3 and 5, the reflector 30 includes a flat bottom plate 32, a tapered sidewall 34 extending outwardly from a periphery of the bottom plate 32, and an annular sidewall 36 extending from a top of the tapered sidewall 34. The two sidewalls 34, 36 of the reflector 30 cooperatively define a near conical chamber 300. The bottom plate 32 is located at a narrow end of the chamber 300 and may have a rectangular recess 320 and a substantially circular opening 322 defined therein. The rectangular recess 320 is located at a lower portion of the bottom plate 32 to receive the base 12 of the LED 10 therein (see FIG. 4). The circular opening 322 cooperates with the rectangular recess 320 to communicate the chamber 300 with an outside at a bottom portion thereof. The circular opening 322 may be smaller than the rectangular recess 320 and located at an upper portion of the bottom plate 32 to receive the substrate 16 of the LED 10 therein. The LED 10 is fittingly received within the reflector 30, with the encapsulant 18 thereof protruding upwardly out of the bottom plate 32. An annular groove 340 may be formed around an inner circumferential surface of the tapered sidewall 34 adjacent to the annular sidewall 36, for engaging the lens 40 therein. The groove 340 forms an annular flat step 342 in the reflector 30, for supporting the lens 40 thereon. A pair of cutouts 38 may be defined in opposite sides of an outer perimeter of the reflector 30. Each cutout 38 spans across a boundary of the annular sidewall 36 and the tapered sidewall 34, such that each cutout 38 has an upper portion communicating with the groove 340, and a lower portion inwardly terminated within the tapered sidewall 34 (see FIG. 2). A pair of locking members 382 may be positioned from opposite sides of the periphery of the bottom plate 32, in the two cutouts 38, respectively. Each locking member 382 may includes a triangle protrusion 384 coupling with a top of the strip 386. A space 386 is defined between a bottom of the protrusion 384 and the step 342, for holding the lens 40 therebetween. The protrusions 384 may be bendable between a vertical orientation where the lens 40 is securely locked in the groove 340 of the reflector 30, and an inwardly inclined orientation where the lens 40 is pressing the protrusions 384 to be locked in the groove 340.

The lens 40 is locked in the reflector 30 at a middle portion of the chamber 300. The lens 40 includes a disk 42 and a dome 44 projecting upwardly from a central area of a top face of the disk 42. The disk 42 may be locked within the groove 380 by an urging force produced by the two protrusions 384, whereby the lens 40 can be secured in the reflector 30. A central area of a bottom face of the lens 40 may have a first aspheric surface 420, facing the encapsulant 18 of the LED 10. An uppermost surface of the dome 44 may be a second aspheric surface 440. The first and second aspheric surfaces 420, 440 can direct the light incident thereto, which is biased a small angle with respect to the optical axis of the lens 40, into substantially parallel light.

The reflector 30 and the lens 40 cooperatively culminate the light, passing through the encapsulant 18 and deflected at a large angle or a small angle with respect to the optical axes of the lens 30 and the reflector 40, into parallel light. From the two aspheric surfaces 420, 440 of the lens 40, nearly 90 percent of the light emitted from the LED 10, can be converged within a 5° angle relative to the optical axis of the catadioptric light distribution system. Thus, most light emitted by the LED 10 can be culminated into a relatively narrow beam with a large intensity, which is less likely to wane after traveling a long distance. In addition, the detachable coupling between the lens 40 and the reflector 30 allows the lens 40 to be conveniently replaced for more flexibility of the catadioptric light distribution system for various illuminating requirements.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An LED unit, comprising:
a reflector;
an LED received in the reflector; and
a lens detachably fixed in the reflector and covering the LED;
wherein the lens has a bottom face facing the LED and a top face away from the LED, at least one of the bottom face and the top face of the lens is an aspheric surface.

2. The LED unit as claimed in claim 1, wherein another one of the bottom face and the top face of the lens is also an aspheric surface.

3. The LED unit as claimed in claim 2, wherein the reflector comprises a bottom plate and a sidewall extending upwardly from the bottom plate; the LED being contained in the bottom plate.

4. The LED unit as claimed in claim 3, wherein the LED comprises a base, an LED die fixed on the base, a substrate fixed on the base and surrounding the LED die, and an encapsulant encapsulating the LED die; the base and the substrate of the LED being accommodated in the bottom plate of the reflector and the encapsulant of the LED extending upwardly beyond the bottom plate.

5. The LED unit as claimed in claim 3, wherein the reflector further comprises a pair of bendable protrusions and a step, and the lens are retained in the reflector between the pair of protrusions and the step.

6. The LED unit as claimed in claim 5, wherein the reflector defines a pair of cutouts in opposite sides of the sidewall thereof, and the pair of protrusions are respectively received in the pair of cutouts.

7. The LED unit as claimed in claim 6, wherein the reflector has a groove defined around an inner perimeter thereof, and the pair of cutouts each have an upper portion communicating with the groove.

8. The LED unit as claimed in claim 7, wherein the lens comprises a disk and a dome projecting upwardly from a central area of a surface of the disk, and the disk engages in the groove and is locked by the pair of protrusions of the reflector.

9. The LED unit as claimed in claim 8, wherein the one aspheric surface is a part of the dome, and the other aspheric surface is a part of the disk.

10. The LED unit as claimed in claim 1, wherein the lens and the reflector are made from a light-permeable material.

11. An LED unit, comprising:
a housing enclosing a conical space;
an LED attached in the housing at a narrow end of the conical space; and
a lens secured in the housing at a middle portion of the conical space, wherein the lens, the LED and the housing are coaxial, and a face of the lens facing the LED is an aspheric surface.

12. The LED unit as claimed in claim 11, wherein another face of the lens away from the LED is an aspheric surface.

13. The LED unit as claimed in claim 11, wherein the housing is a reflector.

14. The LED unit as claimed in claim 11, wherein the lens is detachably fixed in the housing.

15. The LED unit as claimed in claim 11, wherein the housing forms a pair of buckles at opposite sides thereof to abut against the lens.

16. The LED unit as claimed in claim 11, wherein the lens is spaced a distance from the LED.

17. The LED unit as claimed in claim 11, wherein an inner perimeter of the housing is coated with a reflective layer.

18. The LED unit as claimed in claim 17, wherein a material of the reflective layer is chosen from one of gold, copper and ceramic.

19. The LED unit as claimed in claim 18, wherein the housing is made of transparent material.

20. The LED unit as claimed in claim 11, wherein the lens is made of transparent material.
